(19) United States
(12) Patent Application Publication
(10) Pub. No.: US 2002/0158046 A1
(43) Pub. Date: Oct. 31, 2002

(54) Formation of an optical component

(76) Inventors: Chi Wu, San Marino, CA (US); Yiqiong Wang, San Marino, CA (US); Xiaoming Yin, Pasadena, CA (US)

Correspondence Address: ATTN: Terrance A. Meador, GRAY CARY WARE & FREIDENRICH, Suite 1600, 4365 Executive Drive, San Diego, CA, 92121-2189, US

(21) Appl. No.: 09/932,253

(22) Filed: Aug. 16, 2001

Related U.S. Application Data
(63) Continuation-in-part of application No. 09/845,093, filed on Apr. 27, 2001.

(51) Int. Cl. G02B 6/00

(52) U.S. Cl. 216/24; 216/67

(57) ABSTRACT

A method of forming an optical component is disclosed. The method includes obtaining a wafer having a light transmitting medium positioned over a base. The method also includes applying an etching medium to the wafer so as to form one or more surfaces of an optical component in the light transmitting medium. The etching medium is applied in an etching chamber configured to etch a wafer having at least one dimension with a length greater than 6 inches.

### RELATED APPLICATIONS

This application is a continuation-in-part of U.S. patent application Ser. No. 09/845,093; filed on Apr. 27, 2001; entitled “Formation of an Optical Component Having Smooth Sidewalls” and incorporated herein in is entirety.

This application is related to U.S. patent application Ser. No. 09/690,959; filed on Oct. 16, 2000; entitled “Formation of a Vertical Smooth Surface on an Optical Component” and incorporated herein in is entirety.

### BACKGROUND

1. Field of the Invention

The invention relates to formation of optical components. In particular, the invention relates to formation of optical components having waveguides formed in a light transmitting medium positioned over a base.

2. Background of the Invention

A variety of optical networking optical components can be formed on a wafer having a light transmitting medium positioned on a base. These optical components typically include one or more waveguides defined in the light transmitting medium.

A variety of different factors limit fabrication of these optical components. For instance, these optical components often employ silica as the light transmitting medium. Silica typically has a poor thickness uniformity across the wafer and a poor index of refraction uniformity across the wafer. As a result, the waveguides defined in the light transmitting medium can have both a poor thickness uniformity and a poor index of refraction uniformity. A poor thickness uniformity and/or a poor index of refraction uniformity can adversely affect the performance of the optical components. In order to reduce the range of silica thickness values and the range of index of refraction values, optical components having a silica light transmitting medium must be fabricated on small diameter wafers.

The light transmitting medium is typically etched in order to define the one or more waveguides in the light transmitting medium. Performing the etch typically includes applying an etching medium to the light transmitting medium. The uniformity of the etching medium across the light transmitting medium during the etch affects the performance of the optical components. For instance, improving the uniformity of the etching medium provides waveguides with more uniform properties while decreasing the uniformity of the etching medium reduces the uniformity of the waveguide properties. Controlling the uniformity of the etching medium across the wafer becomes more difficult to control as the area of the light transmitting medium increases. Optical components are formed on small diameter wafers in order to achieve a more controllable etching medium uniformity across the wafer.

Another challenge presented by fabrication of optical components is controlling the roughness of surfaces that result from applying the etching medium. For instance, a rough surface can cause scattering and/or undesirable reflection of a light signal. The etching media employed to form optical components are often applied to the wafer in a series of repeated cycles. The Bosch process is an example of an etching technique that employs a series of consecutively repeated cycles. Each cycle includes applying an etching medium to the light transmitting medium followed by applying a passivant to the light transmitting medium. Each cycle results in formation of a bump on the surface being formed. As a result, the repeated cycles is an undesirable source of roughness.

An additional problem associated with the fabrication of optical components is the speed at which the optical components can be fabricated. For instance, the rate at which the surfaces are formed during an etch is often reduced in order to achieve an increased level of smoothness. In some instances, the etch can require more than an hour to form the surfaces. The increased time needed to form the surfaces reduces the output of the optical component formation process.

There is a need for improved methods of fabricating optical components having a light transmitting medium formed on a base.

### SUMMARY OF THE INVENTION

The invention relates to a method of forming an optical component. The method includes obtaining a wafer having a light transmitting medium positioned over a base. The method also includes applying an etching medium to the wafer so as to form one or more surfaces of an optical component in the light transmitting medium. The etching medium is applied in an etching chamber configured to etch a wafer having at least one dimension with a length greater than 6 inches. In some instances, the etching medium is applied in an etching chamber configured to etch a wafer having at least one dimension with a length of at least 7 inches, at least 8 inches, at least 9 inches, at least 10 inches or at least 12 inches.

Another embodiment of the invention includes obtaining a wafer having a light transmitting medium positioned over a base. The wafer has one or more dimensions with a length greater than 6 inches. The method also includes applying an etching medium to the light transmitting medium so as to form one or more surfaces of an optical component in the light transmitting medium. In some instances, the wafer has one or more dimensions with a length of at least 7 inches, at least 8 inches, at least 9 inches, at least 10 inches or at least 12 inches.

Still another embodiment of the invention includes obtaining a wafer having a light transmitting medium positioned over a base. The method also includes applying an etching medium to the light transmitting so as to form one or more surfaces of an optical component to a height greater than 0.5 μm. Application of the etching medium excludes applying the etching medium in one or more repeated cycles during formation of the one or more surfaces. In some instances, the one or more surfaces are formed to a height greater than 1 μm , 2 μm or 3 μm.

Yet another embodiment of the invention includes obtaining a wafer having a light transmitting medium positioned over a base. The method also includes applying an etching medium to the light transmitting so as to form one or more surfaces of an optical component to a height greater than 0.5 μm. The etching medium is continuously applied during formation of the one or more surfaces. In some instances, the etching medium is continuously applied at a flow rate greater than 20 sccm, 50 sccm, 100 sccm, 150 sccm or 200 sccm.

The etching medium can be applied such that the one or more surfaces are formed in a period of time less than one hour, 30 minutes, 25 minutes, 20 minutes, 15 minutes, 10 minutes or 5 minutes. Additionally, the etching medium can be applied so the rate of surface formation is greater than 0.1 μm/min., 0.2 μm/min., 0.5 μm/min., 0.8 μm/min., 1 μm/min., 2 μm/min., 4 μm/min. or 5 μm/min.

In some instances, the one or more surfaces are formed to a height of at least 0.1 μm, 0.2 μm, 0.5 μm, 1 μm, 4 μm, 6 μm, 8 μm, 10 μm or 12 μm.

In some instances, the one or more surfaces include the side of a ridge that defines at least a portion of a waveguide, a facet of a waveguide or a reflecting surface for reflecting light signals.

The etching medium can be applied so the etchant has a uniformity of 20% or less, 10% or less, 5% or less, 3% or less, 2% or less, or 1% or less across the wafer.

In some instances, the light transmitting medium is silicon.

### BRIEF DESCRIPTION OF THE FIGURES

FIG. 1 is a topview of a wafer having a light transmitting medium positioned over a base. The dashed lines illustrate the outline of optical devices formed on the wafer. Each optical device can include one or more optical components.

FIG. 2A is a topview of an optical component formed from a wafer having a light transmitting medium positioned over a base. The optical component includes a light transmitting medium over a base.

FIG. 2B is a cross section of the optical component taken at the line labeled A in FIG. 2A.

FIG. 2C is a sideview of the optical component taken looking in the direction of the arrow labeled B in FIG. 2A.

FIG. 2D illustrates an optical component having a cladding layer formed over the light transmitting medium.

FIG. 2E is a perspective view of an optical component having a reflecting surface positioned so as to reflect light signals from one waveguide into another waveguide.

FIG. 3 is a topview of an optical component constructed according to the construction illustrated in FIG. 2A through FIG. 2C.

FIG. 4A through FIG. 4J illustrate a method of forming an optical component having surfaces that define a waveguide.

FIG. 4K illustrates an optical component having a plurality of waveguides formed according to the method of FIG. 4A through FIG. 4J.

### DETAILED DESCRIPTION OF THE PREFERRED EMBODIMENT

The method relates to a method of forming an optical component. The method includes applying an etching medium to a wafer having a light transmitting medium positioned on a base so as to define one or more surfaces in the light transmitting medium. The one or more surfaces are the surfaces of an optical component.

In one embodiment of the invention, the etching medium is applied to the light transmitting medium in the etching chamber of integrated circuit fabricating equipment. The etching medium includes one or more etchant that provide the etching medium with the etching action. The integrated circuit fabricating equipment has proven to provide a uniformity of etchant across the wafer that is suitable for fabrication of optical components. In some instances, equipment for the fabrication of integrated circuit can provide an etchant uniformity 20% or less, 10% or less, 5% or less, 3% or less, 2% or less, or 1% or less across the wafer where uniformity is one half the difference between the maximum and minimum etchant concentration divided by the average of the etchant concentration measured across the wafer. In some instances, the etchant concentration in a 5 mm region at the edge of the wafer is not taken into account in the etchant uniformity measurement.

The use of integrated circuit fabrication equipment eliminates the need to have equipment designed for the purpose of fabricating optical components. As a result, the costs associated with fabricating optical components is reduced.

The etchant uniformity that can be achieved by the integrated circuit equipment allows for formation of taller surfaces. Many optical components have surfaces that are formed as a result of an etch to a depth of greater than 0.1 μm, 0.2 μm, 0.5 μm, 1 μm, 4 μm, 6 μm, 8 μm, 10 μm or 12 μm. Deeper etches typically require that the wafer be exposed to the etching medium for longer periods of time. As a result, the ability to control the uniformity of the etching medium has an enhanced importance when performing a deeper etch.

Modem integrated circuit etchers typically have an etching chamber configured to etch wafers larger than six inch wafers. Some modem integrated circuit fabrication equipment has an etching chamber configured to etch wafers of at least seven inches, eight inches, ten inches or twelve inches. Accordingly, an embodiment of the invention includes forming optical components in a chamber configured to etch a wafer larger than a six inch wafer. In some instances, the etching medium is applied to a wafer larger than a six inch wafer or to at least a seven inch wafer, at least an eight inch wafer or at least an ten inch wafer. Accordingly, another embodiment of the invention includes forming optical components on a wafer larger than a six inch wafer. The use of larger wafers allows an increased number of optical devices to be formed on a single wafer. Alternatively or additionally, increasing the wafer size can permit an increased number of optical components to be formed on a single optical device. As a result, the increased wafer size can enhance the efficiencies associated with fabrication of optical components and optical devices. Further, the increased wafer size can allow larger and more complex optical devices and optical components to be fabricated on a single wafer. Examples of optical devices that require large amounts of wafer space include Dynamic Gain Equalizers and Add/Drop nodes.

In some instances, the light transmitting medium is silicon. Silicon is associated with a better index of refraction uniformity and a better thickness uniformity across the wafer than is silica. As a result, silicon provides a higher component yield than silica when wafers larger than six inches are employed.

The etching medium can be applied continuously and without consecutively repeated cycles. As a result, the method is not associated with the roughness that results from applying the etching medium is a series of repeated cycles.

Additionally, the etching medium can be applied such that the one or more surfaces are formed in a period of time less than one hour, 30 minutes, 25 minutes, 20 minutes, 15 minutes, 10 minutes or 5 minutes while retaining the desired smoothness. Additionally, the etching medium can be applied so the rate of surface formation is greater than 0.1 μm/min., 0.2 μm/min., 0.5 μm/min., 1 μm/min., 2 μm/min., 4 μm/min. or 5 μm/min while retaining the desired smoothness. As a result, the use of increased wafer dimensions and the continuous etch is not associated with a loss of surface formation speeds.

An example of a suitable etching medium includes a fluorine containing gas, one or more partial passivants and Oxygen. Suitable fluorine containing gasses include, but are not limited to, SF₆, Si₂F₆ or NF₃. Suitable partial passivants include, but are not limited to, HBr, SiF₄, C₄F₈, CH₂F₂ and CHF₃. In one example, the etching medium includes SF₆ as the fluorine containing gas, HBr as the partial passivant and Oxygen.

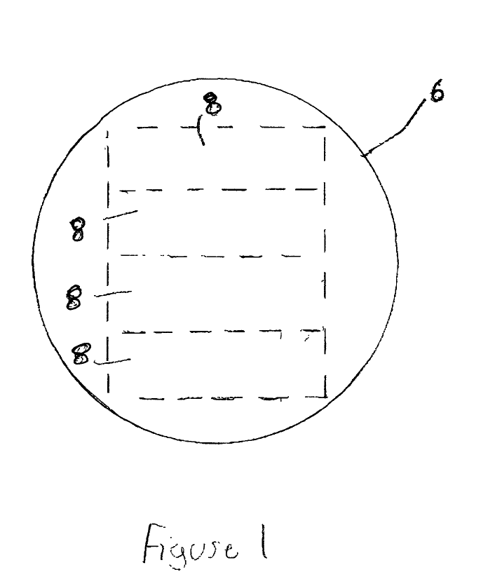

FIG. 1A is a topview of a wafer 6. One or more optical devices 8 can be formed on the wafer 6 as illustrated by the dashed lines. The optical devices 8 can be separated by dicing or other techniques such as etching. Each optical device 8 can include one optical component (not shown). Alternatively, a plurality of optical components can be integrated into a single optical device. When a plurality of optical components are integrated into a single optical device, the optical components can be in optical communication with one another or can be independent of one another. Examples of optical components include, but are not limited to, multiplexers, demultiplexers, switches, attenuators and amplifiers.

Although a round wafer 6 is illustrated, the wafer 6 can have other shapes including, but not limited to, square, rectangular and oval. The size of a wafer 6 generally refers to the largest dimension of the wafer 6. For instance, examples of an eight inch wafer 6 include a round wafer 6 having a diameter of about eight inches, a square wafer 6 having a diagonal of about eight inches, and an oval wafer 6 having a long axis of about eight inches. Accordingly, an eight inch wafer 6 has at least one dimension with a length of about eight inches.

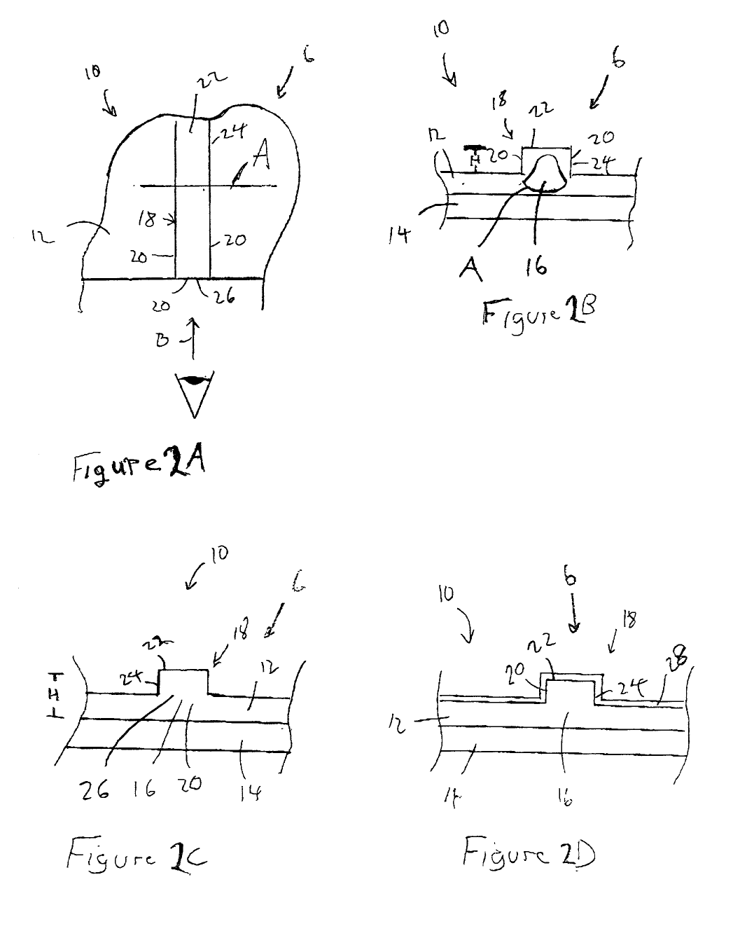

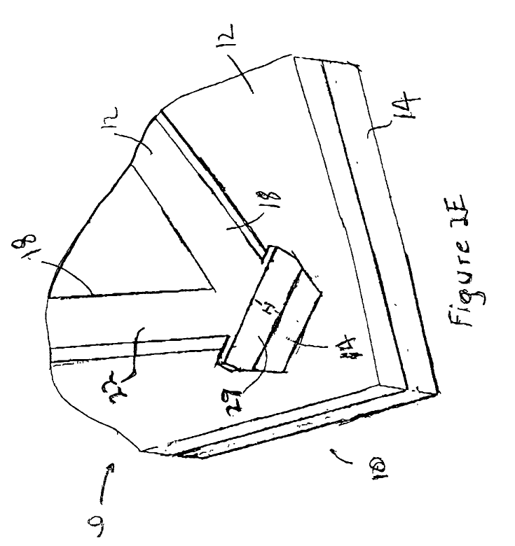

FIG. 2A through FIG. 2C illustrate a suitable construction of an optical component 10 that can be formed on a wafer. FIG. 2A is a topview of a portion of an optical component 10. FIG. 2B is a cross section of a portion of the optical component 10 taken at the line labeled A. FIG. 2C is a sideview of a portion of the optical component 10 taken looking in the direction of the arrow labeled B.

The optical component 10 can be formed from a wafer having a light transmitting medium 12 positioned over a base 14. A suitable light transmitting medium 12 includes, but is not limited to, silicon and silica. A waveguide having a light signal carrying region 16 is defined in the light transmitting medium 12. The line labeled A illustrates the profile of a light signal carried in the light signal carrying region 16.

A ridge 18 defines apportion of the light signal carrying region 16. The ridge 18 is defined by a plurality of surfaces 20 including a top 22 and sidewalls 24. The sidewalls 24 are associated with a height labeled H. Suitable heights for the sidewalls 24 include, but are not limited to, heights greater than 2 μm or heights of at least 3 μm, at least 4 μm, at least 6 μm or at least 8 μm. The top 22 and sidewalls 24 reflect light signals from the light signal carrying region 16 back into the light signal carrying region 16. Accordingly, these surfaces 20 define a portion of the light signal carrying region 16. The light signal can also be scattered by these surfaces 20. Increasing the smoothness of these surfaces 20 can reduce the amount of scattering.

The portion of the base 14 under the ridge 18 includes a material that reflects light signals from the light signal carrying region 16 back into the light signal carrying region 16. As a result, the base 14 also defines a portion of the light signal carrying region 16.

The waveguide ends at a waveguide facet 26 through which light signals enter and/or exit from the optical component 10. The waveguide facet is associated with a height, H. Suitable heights, H, for the waveguide facet include, but are not limited to, heights of at least 4 μm, 6 μm, 8 μm, 10 μm or 12 μm. The waveguide facet 26 is often coupled with an optical fiber to carry light signals to and/or from the optical component 10. The waveguide facet 26 is also a surface 20 where undesirable scattering of light signals can occur. Increasing the smoothness of the waveguide facet 26 can reduce the amount of scattering.

A cladding layer 28 can optionally be formed over the light transmitting medium 12 as shown in FIG. 2D. For instance, when the light transmitting medium 12 is silicon, a suitable cladding layer 28 is silica. Although a cladding layer 28 is shown, other layers such as protective layers can be positioned over the waveguide.

FIG. 2E illustrates an optical component including a reflecting surface 29 positioned at the intersection of a plurality of waveguides. The reflecting surface 29 is configured to reflect light signals from one waveguide into the other waveguide and is associated with a height labeled H. Suitable heights, H, for the waveguide facet include, but are not limited to, heights of at least 4 μm, 6 μm, 8 μm, 10 μm or 12 μm.

The reflecting surface 29 extends below the base of the ridge. For instance, the reflecting surface 29 can extend through the light transmitting medium to the base and in some instances can extend into the base. The reflecting surface 29 extends to the base because the light signal carrying region is positioned in the ridge as well as below the ridge as shown in FIG. 2B. As result, extending the reflecting surface 29 below the base of the ridge increases the portion of the light signal that is reflected.

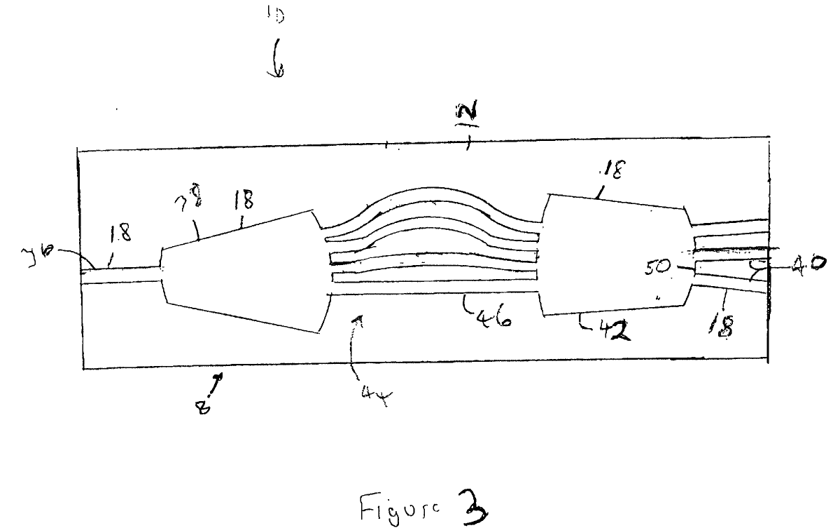

FIG. 3 shows an example of an optical device that can be constructed according to the construction illustrated in FIG. 2A through FIG. 2C. A topview of the optical device is shown. The optical device includes a single optical component. The illustrated optical component 10 is a demultiplexer. The demultiplexer includes at least one input waveguide 36 in optical communication with an input light distribution component 38 and a plurality of output waveguides 40 in optical communication with an output light distribution component 42. A suitable input light distribution component 38 and/or output light distribution component 42 includes, but is not limited to, star couplers, Rowland circles, multi-mode interference devices, mode expanders and slab waveguides.

An array waveguide grating 44 connects the input light distribution component 38 and the output light distribution component 42. The array waveguide grating 44 includes a plurality of array waveguides 46. The length of each array waveguide 46 is different and the difference in the length of adjacent array waveguide(s) 46 is a constant, ΔL. Although three array waveguides 46 are illustrated, array waveguide gratings 44 typically include many more than three array waveguides 46 and fewer are possible. Increasing the number of array waveguides 46 can increase the degree of resolution provided by the array waveguide grating 44.

During operation of the optical component 10, light signals from the input waveguide 36 enter the input light distribution component 38. The input light distribution component 38 distributes the light signal to a plurality of the array waveguides 46. A portion of the light signal travels through each array waveguides 46 into the output light distribution component 42. The output light distribution component 42 combines the portions of the light signal into an output light signal that is focused on an output side 50 of the output light distribution component 42. When the output light signal is focused on a particular output waveguide 40, the light signal is carried by the output waveguide 40.

Because the adjacent array waveguides 46 have different lengths, the light signal from each array waveguide 46 enters the output light distribution component 42 in a different phase. The phase differential causes the light signal to be focused at a particular one of the output waveguides 40. The output waveguide 40 on which the light signal is focused is a function of the wavelength of light of the light signal. Accordingly, light signals of different wavelengths are focused on different output waveguides 40. Hence, each output waveguide 40 carries a light signal of a different wavelength.

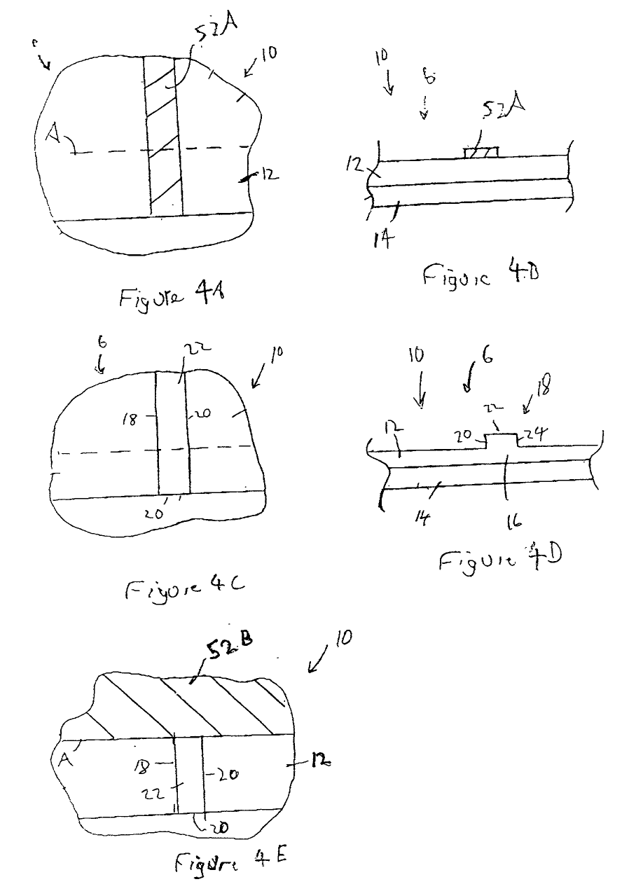

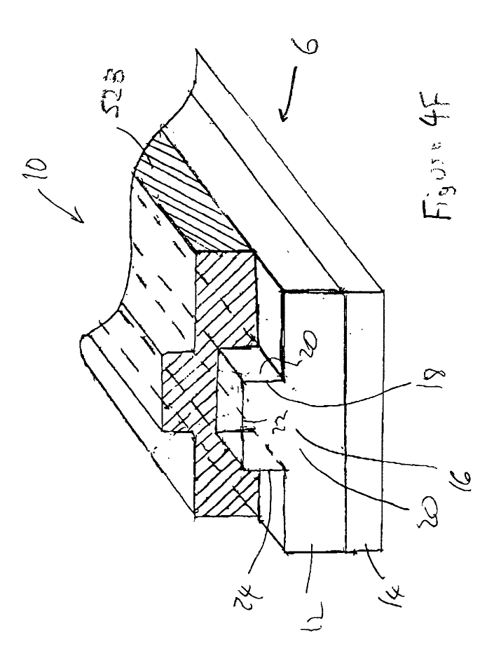

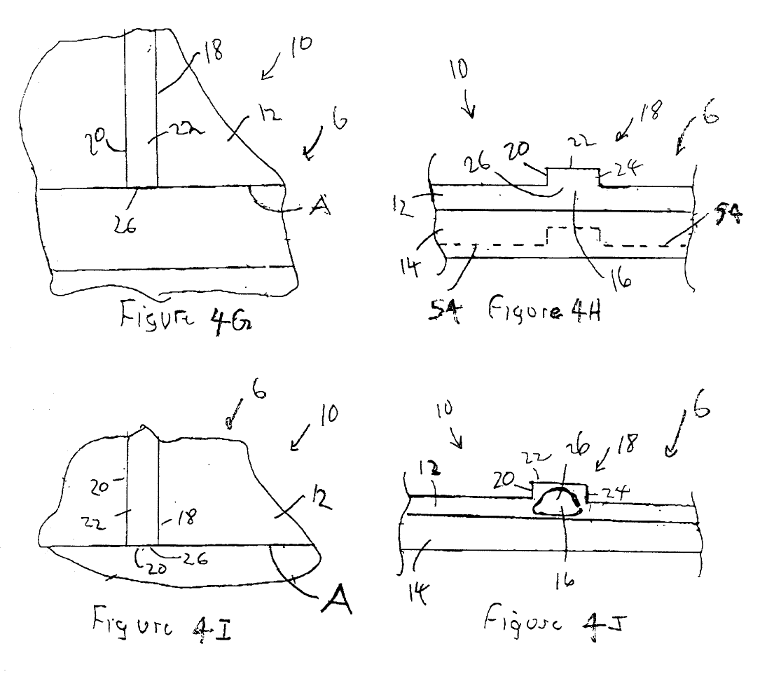

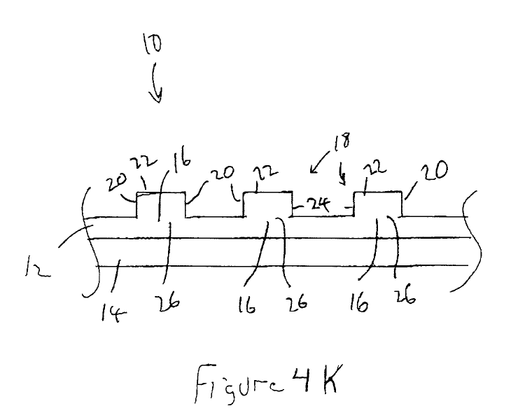

FIG. 4A through FIG. 4J illustrate a method of forming one or more optical components 10 on a wafer 6. Each Figure shows only a portion of an optical component 10 formed on the wafer 6. The wafer 6 can be any size including wafers 6 larger than six inches or wafers 6 of at least seven inches, at least eight inches, at least nine inches, at least ten inches or at least twelve inches.

FIG. 4A is a topview of the wafer 6 and FIG. 4B is a side view of the wafer 6 taken at the dashed line on FIG. 4A. The wafer 6 includes a light transmitting medium 12 positioned over a base 14. The wafer can be obtained from a supplier or can be fabricated. The dashed line denotes the location where the waveguide facet 26 is to be formed. A first mask 52A is formed over the region(s) of the wafer 6 where the ridge 18 of one or more waveguides is to be formed. For the purposes of illustration, formation of a single waveguide is discussed. The waveguide is initially to be formed past the location where the facet is to be formed.

A first etch is performed and the first mask 52A removed to provide the optical component 10 illustrated in FIG. 4C and FIG. 4D. FIG. 4C is a top view of the optical component 10 and FIG. 4D is a cross section of the optical component 10 taken at the dashed line in FIG. 4C. The first etch results in formation of the sidewalls 24 of the ridge 18.

A second mask 52B is formed on the optical component 10 to provide the optical component 10 illustrated in FIG. 4E and FIG. 4F. FIG. 4E is topview of a portion of the optical component 10 and FIG. 4F is a perspective view of a portion of the optical component 10. An edge of the second mask 52B extends across the ridge 18 and is aligned with the location where the waveguide facet 26 is to be formed.

A second etch is performed part way through the wafer 6 and the second mask 52B removed to provide the optical component 10 shown in FIG. 4G and FIG. 4H. FIG. 4G is a topview of the wafer 6 and FIG. 4H is a cross section of the wafer 6 taken at the line labeled A in FIG. 4G. When the second etch is performed part way through the wafer 6, an etch bottom 54 is formed in the wafer 6. For the purposes of illustration, the etch bottom 54 is illustrated by the dashed line in FIG. 4H. The second etch forms the waveguide facet 26.

A portion of the base 14 can be removed to provide the optical component 10 shown in FIG. 4I and FIG. 4J. FIG. 4I is a topview of the optical component 10 and FIG. 4J is a cross section of the optical component 10 taken at the line labeled A in FIG. 4I. The optical component 10 of FIG. 4I and FIG. 4J can also be generated by performing the second etch the way through the wafer 6 instead of part way through the wafer 6.

When FIG. 4I and FIG. 4J is generated by removing a portion of the base 14, the base 14 is removed from the bottom of the base 14 moving toward the etch bottom 54. In some instances the base 14 is removed all the way up to the highest point of the etch bottom 54. Alternatively, a smaller amount of the base 14 or none of the base 14 is removed and the remaining portion of the base 14 can be cracked, cleaved or cut. Suitable methods for removing the base 14 include, but are not limited to, polishing, milling or etching the bottom of the wafer 6. Further, the substrate can be selectively removed by forming a second groove into the bottom of the base 14 opposite the groove formed by the second etch. Additionally, the wafer 6 can be cut through the bottom of the base 14 to the etch bottom 54.

A cladding layer 28 can optionally be formed over the light transmitting medium 12 shown in FIG. 4J. When the light transmitting medium 12 is silicon, a silica cladding layer 28 can be formed by exposing the silicon to air at ambient conditions, by a thermal oxide treatment or by a chemical vapor deposition (CVD).

Although the method shown in FIG. 4A through FIG. 4J illustrate formation of an optical component 10 having a single waveguide, the method can be adapted to formation of an optical component 10 having a plurality of waveguides. FIG. 4K shows a cross section of an optical component 10 having a plurality of waveguides. The first and/or second etch can be performed so as to concurrently form one or more surfaces 20 on more than one of the waveguide.

The sidewalls 24 of the ridge 18 are formed as a result of the first etch. The waveguide facet 26 is formed as a result of the second etch. As noted above, these surfaces 20 are preferably smooth in order to reduce scattering of light signals. The mask employed during the etch is the largely the source of the vertical surface smoothness. A suitable mask includes, but is not limited to, an oxide mask. The first etch and/or the second etch are largely the source of the horizontal surface smoothness.

A suitable method of performing the first etch and/or the second etch includes placing the wafer in an etching chamber and applying an etching medium to the light transmitting medium. Etching chambers are configured to etch wafers up to a particular size. For instance, the dimensions of the chamber can be sized to etch wafers of a particular size or the coil(s) used as an energy source can be configured to provide uniform plasma density to a wafer of a particular size.

The etching chamber can be an etching chamber configured to etch wafers larger than six inch wafers, an etching chamber configured to etch wafers of at least seven inches, at least eight inches, at least nine inches, at least ten inches or at least twelve inches. In some instances, the etching chamber is an etching chamber designed for fabrication of integrated circuits such as the etching chamber of a “DECOUPLED PLASMA SOURCE DEEP TRENCH” etcher (“DPS DT”) manufactured by Applied Materials, Inc.

The etching medium can be applied so as to have a uniformity across the wafer of less than 20% or less, 10% or less, 5% or less, 3% or less, 2% or less, or 1% or less.

The selection of the components in the etching medium can affect the ability to control the uniformity of the etching medium across the wafer. Accordingly, the etching medium can be selected so as to provide a particular uniformity across the wafer. A suitable etching medium includes a fluorine containing gas, one or more partial passivants and oxygen. The fluorine containing gas serves as an etchant. Suitable fluorine containing gases include, but are not limited to, SF₆, Si₂F₆ and NF₃. A partial passivant can have both etchant and passivant characteristics depending on the conditions under which the etching medium is applied. A passivant is a medium that causes formation of a protective layer during the etch. The protective layer protects the light transmitting medium from the etchant. A suitable protective layer is a polymer layer. Suitable partial passivants include, but are not limited to, HBr, C₄F₈, SiF₄ or CHₓF_{y} such as CH₂F₂, or CHF₃. When the light transmitting medium 12 is Si, HBr can act as a passivant by reacting with the Si to form a protective layer of SiBrₓ or SiBrₓO_{y} and CHₓF_{y} can act as a passivant by reacting with the Si to form a protective layer of SiF. The oxygen acts as a passivant that serves to form a protective layer during the etch.

An etching medium including a fluorine containing gas, one or more partial passivants and oxygen allows for quicker etch rates while retaining the desired level of smoothness. For instance, when the light transmitting medium is silicon and the etching medium includes SF₆ as the fluorine containing gas, HBr as the partial passivant, Oxygen as the passivant and SiF₄; the etching medium can be applied in the first etch and/or the second etch to form surfaces up to 12 μm in height in less than one hour, 30 minutes, 25 minutes, 20 minutes, 15 minutes, 10 minutes or 5 minutes. Additionally, the etching medium can be applied in the first etch and/or the second etch to form surfaces at a rate of greater than 0.1 μm/min., 0.2 μm/min., 0.5 μm/min., 1 μm/min., 2 μm/min., 4 μm/min. or 5 μm/min. The above times and rates can be achieved while retaining a smoothness less than 150 nm, 100 nm, 75 μnm, 50 μm, 25 μm, 10 μm and in some instances less than 5 μm.

When the light transmitting medium 12 is silicon, suitable smoothness can be achieved when the etching medium has a molar ratio of partial passivant to fluorine containing gas in the range of 0.1 to 100, 0.5 to 20, 2 to 15 or 6 to 12 (inclusive). Additionally, when the light transmitting medium 12 is silicon, suitable smoothness can be achieved when the etching medium has a molar ratio of fluorine containing gas to oxygen in the range of 0.1 to 10 or 0.2 to 5 (inclusive). Higher partial passivant ratios can provide increased levels of smoothness because the protection of the light transmitting medium is increased. However, the etching rate slows as the ratio increases. Accordingly, the advantages of the increased smoothness should be balanced against the increased fabrication time.

In some instances, the etching medium is applied at a chamber pressure of 1 mTorr to 600 mTorr, 1 mTorr to 200 mTorr, 1 mTorr to 60 mTorr, 1 mTorr to 30 mTorr or 10 mTorr to 20 mTorr. When the etching medium is applied in a directional etch, lower pressures can increase the degree of smoothness achieved by the etch because the lower pressure allows for a higher degree of directionality. Suitable chamber, or cathode, temperatures during application of the etching medium include, but are not limited to, 10 ° C. to 50 ° C.

A suitable etch for applying the etching medium includes, but is not limited to, an inductively coupled reactive ion etch (RIE), a capacitively coupled RIE, a magnetically field enhanced RIE (MERIE), a helicon plasma RIE, electron cyclotron resonance (ECR) plasma RIE and other high density plasma etches. The etcher selection can influence the action of the partial passivant. For instance, an inductively coupled plasma may apply lower ion energy than results from a capacitively coupled reactive ion etch. The reduced ion energy causes the HBr to acts as a partial passivant. However, in a capacitively coupled reactive ion etch, the HBr would act as an etchant.

Other components can be added to the etching medium to improve the performance of the etching medium. For instance, the etching medium can include Si₂F₆ and/or SiF₄ in addition to the fluorine containing gas. In one example, the etching medium includes SF₆ as the fluorine containing gas, HBr as the partial passivant, Oxygen as the passivant and SiF₄. When an oxide mask is employed during application of the etching medium, the SiF₄ can increase the selectivity of the etching medium for the light transmitting medium 12 over the mask. More specifically, the Si from the SiF₄ can reacts with the Oxygen to form SiO₂ on the oxide mask.

Another component that can be added to the etching medium is a noble gas such as Ar, He and Xe. The noble gas can serve to enhance ion bombardment and improve etch uniformity across the wafer.

A particular example of the etching medium includes SF₆ as the fluorine containing gas, HBr as the partial passivant and Oxygen. This etching medium has been shown to provide an etchant uniformities of less than 5% when applied in a “DPS DT” etching chamber. Increasing the degree of etching medium uniformity allows the size of the wafers on which the surfaces are formed to be increased. Increasing the degree of etching medium uniformity allows these surfaces to be formed to larger heights without a decrease in performance. For instance, the surfaces on an optical component can be formed to a height greater than 2 μm or to a height of at least 4 μm, at least 5 μm, at least 6 μm, at least 8 μm or at least 10 μm.

The etching medium can be applied continuously during the formation of a surface. For instance, the etching medium can be applied without disruption during the formation of a surface. In some instances, the etching medium is continuously applied at a flow rate greater than 20 sccm, 50 sccm, 100 sccm, 150 sccm or 200 sccm.

Additionally or alternatively, application of the etching medium can exclude applying the etching medium in consecutively repeated cycles. An examples of applying the etching medium in a consecutively repeated cycle includes, but is not limited to, applying the etching medium such that the flow rate of the etching medium goes through a cycle that is repeated one or more times during the formation of a surface. For instance, an etching medium that includes SF₆, HBr and Oxygen can be continuously applied without repeated cycles to achieve a suitable level of etching medium uniformity and surface smoothness. In some instances, application of the etching medium can exclude applying one or more components of the etching medium in consecutively repeated cycles.

The content of the etching medium can change during the formation of the surface although the etching medium is applied continuously and without consecutively repeated cycles. For instance, when the etching medium is being employed to form a ridge and includes a fluorine containing gas, the portion of the etching medium that is fluorine containing gas can be increased as the etching medium is applied to causes the surface to undercut the ridge while decreasing the portion of the etching medium that is fluorine containing gas causes the surface to be undercut to extend away from the ridge. Accordingly, the composition of the etching medium can be controlled so as to control the level of verticality of a surface.

### EXAMPLE 1

The following example is performed on a Decoupled Plasma Source Deep Trench etcher (DPS DT) manufactured by Applied Materials. An eight inch wafer having a light transmitting medium on a base is positioned in the etching chamber of the DPS DT. The wafer includes silicon as the light transmitting medium 12. One or more portions of the wafer are masked with an oxide mask. An etching medium having SF₆ as the fluorine containing gas, HBr as the partial passivant and Oxygen is applied to the exposed light transmitting medium. The SF₆ flow rate is about 40 sccm, the HBr flow rate is about 240 sccm and the Oxygen flow rate is 36 sccm so as to maintain the chamber pressure at about 10 mTorr and the uniformity of the etching medium across the wafer is better than 20%. The coil is operated at 1000 W and 13.56 MHz. The cathode is operated at 50 W and 400 KHz and at a temperature of about 10 ° C. to 20 ° C. The etch results in the formation of the sides of ridges on a plurality of optical components 10 on the wafer. The etching medium is continuously applied without repeated cycles for a period of time need to form the surface 20 to the desired height. Performing an etch under these conditions can produce a horizontal smoothness on the order of 7 nm and a depth uniformity of about 2%.

The example of FIG. 4A through FIG. 4J shows different surfaces 20 of the optical component 10 formed with different etches. For instance, the waveguide sidewalls 24 were formed during the first etch and the waveguide facet 26 was formed during the second etch. When different surfaces 20 are formed with different etches, the etching medium need not be the same during different etches. Additionally, every etch need not include an etching medium according to the present invention.

The method disclosed in FIG. 4A through FIG. 4J are shown for the purposes of illustrating an example of a method of forming an optical component. The same optical components can be formed using a variety of different methods. When these methods employ an etch to form a surface on the component, the etches according to the present invention can be employed to form these components. Additionally, the etches can be employed to form surfaces other than facets and sidewalls. For instance, the etches can be employed to form a reflecting surface 29 such as the reflecting surface 29 shown in FIG. 2E. A suitable method for forming a reflecting surface 29 is taught in U.S. patent application Ser. No. 09/723757, filed on Nov. 28, 2000, entitled “Formation of a Reflecting Surface on an Optical Component” and incorporated herein in its entirety.

Although the etching medium is disclosed in the context of forming a surface 20 of a ridge 18 waveguide, the etching medium can be employed to form surfaces 20 on other waveguides. Examples of other waveguides having surfaces 20 that can be formed with the etching medium include, but are not limited to, channel waveguides, buried channel waveguides, and strip waveguides.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A method of forming an optical component, comprising:
obtaining a wafer having a light transmitting medium positioned over a base; and
applying an etching medium to the wafer so as to form one or more surfaces of an optical component in the light transmitting medium, the etching medium being applied in an etching chamber configured to etch wafers having at least one dimension with a length greater than 6 inches.

2. The method of claim 1, wherein the etching medium is applied in an etching chamber configured to etch a wafer having at least one dimension of at least 7 inches.

3. The method of claim 1, wherein the etching medium is applied in an etching chamber configured to etch a wafer having at least one dimension of at least 8 inches.

4. The method of claim 1, wherein the wafer has one or more dimensions with a length greater than 6 inches.

5. The method of claim 1, wherein the wafer has one or more dimensions with a length of at least 8 inches.

6. The method of claim 1, wherein at least a portion of the one or more surfaces are formed in less than 20 minutes.

7. The method of claim 1, wherein at least a portion of the one or more surfaces are formed in less than 10 minutes.

8. The method of claim 1, wherein the etching medium is applied so as to form at least a portion of the one or more surfaces at a rate of at least 0.1 μm/min.

9. The method of claim 8, wherein the portion of the one or more surfaces are formed with a smoothness of at most 25 μm.

10. The method of claim 1, wherein the etching medium is applied so as to form at least a portion of the one or more surfaces at a rate of at least 0.8 μm/min.

11. The method of claim 10, wherein the portion of the one or more surfaces are formed with a smoothness of at most 25 μnm.

12. The method of claim 1, wherein the etching medium is applied so as to form at least a portion of the one or more surfaces at a rate of at least 1.5 μm/min.

13. The method of claim 1, wherein the one or more surfaces include a side of a waveguide.

14. The method of claim 1, wherein the one or more surfaces include sides of a ridge, the ridge defining at least a portion of a waveguide.

15. The method of claim 1, wherein the etching medium is applied continuously during formation of the one or more surfaces.

16. The method of claim 1, wherein applying the etching medium excludes applying the etching medium in consecutively repeated cycles.

17. The method of claim 1, wherein the one or more surfaces are formed to a height greater than 2 μm.

18. The method of claim 1, wherein the one or more surfaces are formed to a height of a least 4 μm.

19. The method of claim 1, wherein the one or more surfaces are formed to a height of at least 6 μm.

20. The method of claim 16, wherein the one or more surfaces are formed to a height greater than 2 μm.

21. The method of claim 16, wherein the one or more surfaces are formed to a height greater than 4 μm.

22. The method of claim 16, wherein the one or more surfaces are formed to a height greater than 2 μm.

23. The method of claim 16, wherein the one or more surfaces are formed to a height greater than 4 μm.

24. The method of claim 1, wherein the light transmitting medium is silicon.

25. The method of claim 1, wherein the etching medium includes an etchant and the etching medium is applied such that the etchant has a uniformity of 20% or less across the surface of the wafer.

26. The method of claim 1, wherein the etching medium includes an etchant and the etching medium is applied such that the etchant has a uniformity of 10% or less across the surface of the wafer.

27. A method of forming an optical component, comprising:
obtaining a wafer having a light transmitting medium positioned over a base, the wafer having one or more dimensions with a length greater than 6 inches; and
applying an etching medium to the wafer so as to form one or more surfaces in the light transmitting medium, the one or more surfaces including a surface of an optical component.

28. The method of claim 27, wherein the wafer has one or more dimensions with a length of at least 8 inches.

29. The method of claim 27, wherein the wafer has one or more dimensions with a length of at least 10 inches.

30. The method of claim 27, wherein the etching medium is applied in an etching chamber configured to etch a wafer having at least one dimension of at least seven inches.

31. The method of claim 27, wherein the etching medium is applied in an etching chamber configured to etch a wafer having at least one dimension of at least eight inches.

32. The method of claim 27, wherein the one or more surfaces include a side of a waveguide.

33. The method of claim 27, wherein the one or more surfaces include sides of a ridge, the ridge defining at least a portion of a waveguide.

34. The method of claim 27, wherein the etching medium is applied continuously during formation of the one or more surfaces.

35. The method of claim 27, wherein applying the etching medium excludes applying the etching medium in consecutively repeated cycles.

36. The method of claim 27, wherein the light transmitting medium is silicon.

37. The method of claim 27, wherein the etching medium includes an etchant and the etching medium is applied such that the etchant has a uniformity of 20% or less across the surface of the wafer.

38. The method of claim 27, wherein the etching medium includes an etchant and the etching medium is applied such that the etchant has a uniformity of 10% or less across the surface of the wafer.

39. A method of forming an optical component, comprising:
obtaining a wafer having a light transmitting medium positioned over a base; and
applying an etching medium to the light transmitting so as to form one or more surfaces of an optical component to a height greater than 2 μm, application of the etching medium excluding applying the etching medium in one or more repeated cycles during formation of the one or more surfaces.

40. The method of claim 39, wherein the one or more surfaces are formed to a height of at least 4 μm.

41. The method of claim 39, wherein the one or more surfaces are formed to a height of at least 6 μm.

42. The method of claim 39, wherein at least a portion of the one or more surfaces are formed in less than 20 minutes.

43. The method of claim 39, wherein at least a portion of the one or more surfaces are formed in less than 10 minutes.

44. The method of claim 39, wherein the etching medium is applied so as to form at least a portion of the one or more surfaces at a rate of at least 0.1 μm/min.

45. The method of claim 44, wherein the portion of the one or more surfaces are formed with a smoothness of at most 25 μm.

46. The method of claim 39, wherein the etching medium is applied so as to form at least a portion of the one or more surfaces at a rate of at least 0.8 μm/min.

47. The method of claim 46, wherein the portion of the one or more surfaces are formed with a smoothness of at most 25 μm.

48. The method of claim 39, wherein the etching medium is applied so as to form at least a portion of the one or more surfaces at a rate of at least 1.5 μm/min.

49. The method of claim 39, wherein the etching medium is applied in an etching chamber configured to etch a wafer having at least one dimension with a length greater than 6 inches.

50. The method of claim 39, wherein the etching medium is applied in an etching chamber configured to etch a wafer having at least one dimension of at least 7 inches.

51. The method of claim 39, wherein the etching medium is applied in an etching chamber configured to etch a wafer having at least one dimension of at least 8 inches.

52. The method of claim 39, wherein the wafer has one or more dimensions with a length greater than 6 inches.

53. The method of claim 39, wherein the wafer has one or more dimensions with a length of at least 8 inches.

54. The method of claim 39, wherein the light transmitting medium is silicon.

55. The method of claim 39, wherein the etching medium is applied continuously during formation of the one or more surfaces.

56. The method of claim 39, wherein the one or more surfaces include sides of a ridge, the ridge defining at least a portion of a waveguide.

57. A method of forming an optical component, comprising:
obtaining a wafer having a light transmitting medium positioned over a base; and
applying an etching medium to the light transmitting so as to form one or more surfaces of an optical component to a height greater than 2 μm, the etching medium being continuously applied during formation of the one or more surfaces.

58. The method of claim 57, wherein at least a portion of the one or more surfaces are formed in less than 20 minutes.

59. The method of claim 57, wherein at least a portion of the one or more surfaces are formed in less than 10 minutes.

60. The method of claim 57, wherein the etching medium is applied so as to form at least a portion of the one or more surfaces at a rate of at least 0.1 μm/min.

61. The method of claim 60, wherein the portion of the one or more surfaces are formed with a smoothness of at most 25 μm.

62. The method of claim 57, wherein the etching medium is applied so as to form at least a portion of the one or more surfaces at a rate of at least 0.8 μm/min.

63. The method of claim 62, wherein the portion of the one or more surfaces are formed with a smoothness of at most 25 nm.

64. The method of claim 57, wherein the etching medium is applied so as to form at least a portion of the one or more surfaces at a rate of at least 1.5 μm/min.

65. The method of claim 57, wherein the one or more surfaces are formed to a height greater than 2 μm.

66. The method of claim 57, wherein the one or more surfaces are formed to a height of at least 4 μm.

67. The method of claim 57, wherein the one or more surfaces are formed to a height of at least 6 μm.

68. The method of claim 57, wherein the etching medium is applied in an etching chamber configured to etch a wafer having at least one dimension with a length greater than 6 inches.

69. The method of claim 57, wherein the etching medium is applied in an etching chamber configured to etch a wafer having at least one dimension of at least 8 inches.

70. The method of claim 57, wherein the wafer has one or more dimensions with a length greater than 6 inches.

71. The method of claim 57, wherein the wafer has one or more dimensions with a length of at least 8 inches.

72. The method of claim 57, wherein the light transmitting medium is silicon.
